(19) United States
(12) Patent Application Publication
(10) Pub. No.: US 2013/0118980 A1
(43) Pub. Date: May 16, 2013

(54) POLYMERIC MATERIAL, PRODUCTION AND USE THEREOF

(71) Applicants: ANNA MUELLER-CRISTADORO, Waldems (DE); Helmut Moehwald, Annweiler (DE); Jelan Kuhn, Heidelberg (DE)

(72) Inventors: ANNA MUELLER-CRISTADORO, Waldems (DE); Helmut Moehwald, Annweiler (DE); Jelan Kuhn, Heidelberg (DE)

(21) Appl. No.: 13/676,439

(22) Filed: Nov. 14, 2012

Related U.S. Application Data
(60) Provisional application No. 61/560,305, filed on Nov. 16, 2011.

(51) Int. Cl. B01D 15/10; B01D 61/00; C08G 18/76

(52) U.S. Cl. CPC B01D 15/10; C08G 18/7657; B01D 61/00
USPC 210/650; 528/59; 210/656

(57) ABSTRACT

The present invention relates to a polymeric material obtainable by reaction of
(A) at least one polyimide selected from condensation products of
   (a) at least one polyisocyanate having on average at least two isocyanate groups per molecule and
   (b) at least one polycarboxylic acid having at least 3 COOH groups per molecule or anhydride thereof,
(B) at least one diol or triol.

The present invention relates to a polymeric material obtainable by reaction of
(A) at least one polyimide selected from condensation products of
   (a) at least one polyisocyanate having on average at least two isocyanate groups per molecule and
   (b) at least one polycarboxylic acid having at least 3 COOH groups per molecule or anhydride thereof, with
(B) at least one diol or triol.

In addition, the present invention relates to the production of polymeric materials according to the invention and use thereof for separation of matter, in particular as membranes, for example in membrane separation methods, for example in ultrafiltration, nanofiltration, pervaporation, reverse osmosis and gas separation.

For membrane separation methods, for example for ultrafiltration, for nanofiltration, for pervaporation, for reverse osmosis and for gas separation, usually membranes are used, of which challenging demands are made. Frequently, inorganic membranes or polymeric membranes are used.

Inorganic membranes which may be mentioned are, for example, TiO₂ and ZrO₂ membranes, in addition zeolite membranes. Inorganic membranes, however, frequently have the disadvantage that they exhibit a certain brittleness and therefore can break under a mechanical load.

Hereinafter, materials for separation of matter are taken to mean those materials which, for example by adsorption-desorption processes or via differing permeability properties, permit the separation or enrichment of individual components from mixtures of matter. Those which may be mentioned are, for example, membranes and stationary phases for chromatography columns.

In addition to the price, for materials for separation of matter, in particular factors such as selectivity, permeability and mechanical stability, in particular at a high feed pressure, play a role. Furthermore, materials for separation of matter in organic solvents must swell only slightly.

Recently, it has frequently been proposed to use polymers as materials for separation of matter. Thus, certain polyimides that carry bis-trifluoromethyldiphenylidenemethane units have already been proposed, see, for example, W. J. Koros et al., J. Membr. Sci. 1988, 37, 45; C. Staudt-Bickel et al., J. Membr. Sci. 1999, 155, 145, and the literature cited therein. Although the polyimides described in the cited passages can be used under certain conditions for separating olefin-alkane mixtures, in the case of separations under industrially interesting conditions, in many cases severe swelling occurs, which adversely affects the mechanical properties of, for example, membranes. Furthermore, the proposed materials are laborious to produce and therefore are unfavorable in terms of costs.

In US 2010/0038306, membrane materials for nanofiltration are described which can be obtained by reacting polyimides with diamines. Diamines remaining in the material, however, are a cause of concern, and can only be removed in a laborious route.

The object was therefore to provide materials which are highly suitable as materials for separation of matter and which have good mechanical properties, in particular are not brittle, and which furthermore do not exhibit disadvantageous swelling behavior.

Accordingly, the polymeric materials defined at the outset have been found. Polymeric materials according to the invention are obtainable by reaction of

(A) at least one polyimide, also termed polyimide (A), selected from condensation products of
(a) at least one polyisocyanate having on average at least two isocyanate groups per molecule, called polyisocyanate (a) for short, and
(b) at least one polycarboxylic acid having at least 3 COOH groups per molecule, called polycarboxylic acid (b) for short, or anhydride thereof, called anhydride (b) for short, and
   (B) at least one diol, hereinafter also called diol (B).

Polyimide (A) which is linear or branched and is selected from condensation products of
(a) at least one polyisocyanate having on average more than two isocyanate groups per molecule and
(b) at least one polycarboxylic acid having at least 3 COOH groups per molecule or anhydride thereof.

Polyimide (A) can have a molecular weight M_{w} in the range from 500 to 200 000 g/mol, preferably at least 1000 g/mol.

Polyimide (A) can have at least two imide groups per molecule, preferably at least 3 imide groups per molecule.

In one embodiment of the present invention, polyimide (A) can have up to 1000 imide groups per molecule, preferably up to 660 per molecule.

In one embodiment of the present invention, the statement of the isocyanate groups or of the COOH groups per molecule in each case means the average value (number average).

Polyimide (A) can be composed of structurally and molecularly uniform molecules. However, it is preferred when polyimide (A) is a mixture of molecularly and structurally differing molecules, for example apparent in polydispersity M_{w}/Mₙ of at least 1.4, preferably M_{w}/Mₙ from 1.4 to 50, preferably 1.5 to 10. The polydispersity can be determined by known methods, in particular by gel permeation chromatography (GPC). A suitable standard is, for example, polymethyl methacrylate (PMMA).

In one embodiment of the present invention, polyimide (A), in addition to imide groups which form the polymer backbone, has as terminal or side-chain, at least three, preferably at least six, more preferably at least ten terminal or side-chain functional groups, also termed branches. Functional groups in polyimide (A) are preferably anhydride or acid groups and/or free or capped NCO groups. Polyimides (A) preferably have no more than 500 terminal or side-chain functional groups, preferably no more than 100.

Alkyl groups such as methyl groups, for example, are therefore not a branching of a molecule of polyimide (A).

Polyisocyanate (a) can be selected from any desired polyisocyanates that have on average at least two isocyanate groups per molecule which can be present capped, or preferably free. Preferred polyisocyanates (a) are diisocyanates, for example hexamethylene diisocyanate, isophorone diisocyanate, toluoylene diisocyanate, 4,4′-diphenylmethane diisocyanate, 2,4′-diphenylmethane diisocyanate, and mixtures of at least two of the above-mentioned polyisocyanates (a). Preferred mixtures are mixtures of 4,4′-diphenylmethane diisocyanate and 2,4′-diphenylmethane diisocyanate and mixtures of 2,4-toluoylene diisocyanate and 2,6-toluoylene diisocyanate.

In another embodiment of the present invention, polyisocyanate (a) is selected from oligomeric hexamethylene diisocyanate, oligomeric tetramethylene diisocyanate, oligomeric isophorone diisocyanate, oligomeric diphenylmethane diisocyanate, trimeric toluoylene diisocyanate and mixtures of at least two of the abovementioned polyisocyanates (a). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate.

In one embodiment of the present invention, polyisocyanate (a) is a mixture of at least one diisocyanate and at least one triisocyanate or a polyisocyanate having at least 4 isocyanate groups per molecule.

In one embodiment of the present invention, polyisocyanate (a) has on average exactly 2.0 isocyanate groups per molecule. In another embodiment of the present invention, polyisocyanate (a) has on average at least 2.2, preferably at least 2.5, particularly preferably at least 3.0, isocyanate groups per molecule.

In one embodiment of the present invention, polyisocyanate (a) has on average up to 8, preferably up to 6, isocyanate groups per molecule.

In one embodiment of the present invention, polyisocyanate (a) is selected from oligomeric hexamethylene diisocyanate, oligomeric isophorone diisocyanate, oligomeric diphenylmethane diisocyanate and mixtures of the abovementioned polyisocyanates.

Polyisocyanate (a), in addition to urethane groups, can also have one or more other functional groups, for example urea, allophanate, biuret, carbodiimide, amide, ester, ether, uretonimine, uretdione, isocyanurate or oxazolidine groups.

As polycarboxylic acids (b), aliphatic or preferably aromatic polycarboxylic acids are selected that have at least three COOH groups per molecule, or the respective anhydrides, preferably when they are in the low-molecular weight form, that is to say the non-polymer form. Those polycarboxylic acids having 3 COOH groups in which two carboxylic acid groups are present as anhydride and the third as free carboxylic acid are also included.

In a preferred embodiment of the present invention, as polycarboxylic acid (b), a polycarboxylic acid having at least 4 COOH groups per molecule is selected, or the respective anhydride.

Examples of polycarboxylic acids (b) and anhydrides thereof are 1,2,3-benzenetricarboxylic acid and 1,2,3-benzenetricarboxylic anhydride, 1,3,5-benzenetricarboxylic acid (trimesic acid), preferably 1,2,4-benzenetricarboxylic acid (trimellitic acid), trimellitic anhydride and, in particular, 1,2,4,5-benzenetetracarboxylic acid (pyromellitic acid) and 1,2,4,5-benzenetetracarboxylic dianhydride (pyromellitic dianhydride), 3,3′,4,4′-benzophenonetetracarboxylic acid, 3,3′,4,4′-benzophenonetetracarboxylic dianhydride, in addition benzenehexacarboxylic acid (mellitic acid) and anhydrides of mellitic acid.

Other suitable polycarboxylic acids and anhydrides thereof are mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxyphenyl)methane and bis(2,3-dicarboxyphenyl)methane dianhydride, bis(3,4-dicarboxyphenyl)methane and bis(3,4-dicarboxyphenyl)methane dianhydride, 1,1-bis(2,3-dicarboxyphenyl)ethane and 1,1-bis(2,3-dicarboxyphenyl)ethane dianhydride, 1,1-bis(3,4-dicarboxyphenyl)ethane and 1,1-bis(3,4-dicarboxyphenyl)ethane dianhydride, 2,2-bis(2,3-dicarboxyphenyl)propane and 2,2-bis(2,3-dicarboxyphenyl)propane dianhydride, 2,3-bis(3,4-dicarboxyphenyl)propane and 2,3-bis(3,4-dicarboxyphenyl)propane dianhydride, bis(3,4-carboxyphenyl)sulfone and bis(3,4-carboxyphenyl)sulfone dianhydride, bis(3,4-carboxyphenyl)ether and bis(3,4-carboxyphenyl)ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

In one embodiment of the present invention, anhydrides from U.S. Pat. No. 2,155,687 or U.S. Pat. No. 3,277,117 are used for the synthesis of polyimide (A).

If polyisocyanate (a) and polycarboxylic acid (b) are condensed with one another—preferably in the presence of a catalyst—then an imide group is formed with elimination of CO₂ and H₂O. If, instead of polycarboxylic acid (b), the corresponding anhydride is used, then an imide group is formed with elimination of CO₂.

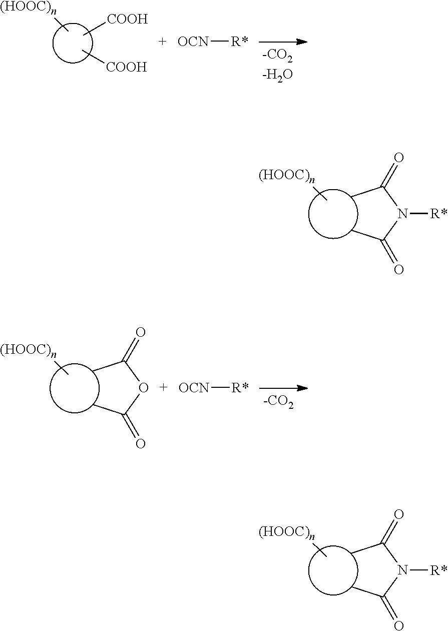

In this case R* is the radical of polyisocyanate (a) not specified further in the above reaction equation, and n is a number greater than or equal to 1, for example 1 in the case of a tricarboxylic acid or 2 in the case of a tetracarboxylic acid, wherein (HOOC)ₙ can be replaced by an anhydride group of the formula C(═O)—O—C(═O).

In one embodiment of the present invention, polyisocyanate (a) is used in a mixture with at least one diisocyanate, for example with toluoylene diisocyanate, hexamethylene diisocyanate or with isophorone diisocyanate. In a particular variant, polyisocyanate (a) is used in a mixture with the corresponding diisocyanate, for example trimeric HDI with hexamethylene diisocyanate, or trimeric isophorone diisocyanate with isophorone diisocyanate, or polymeric diphenylmethane diisocyanate (polymer MDI) with diphenylmethane diisocyanate.

In one embodiment of the present invention, polycarboxylic acid (b) is used in a mixture with at least one dicarboxylic acid or with at least one dicarboxylic anhydride, for example with phthalic acid or phthalic anhydride.

Diol (B) or triol (B) can be low-molecular-weight or high-molecular-weight. Examples of triols (B) are glycerol and 1,1,1-(trihydroxymethylene)methane, 1,1,1-(trihydroxymethylene)ethane and 1,1,1-(trihydroxymethylene)propane.

Diols (B) are preferred.

As low-molecular-weight diols (B) in the context of the present invention, those having a molecular weight up to 500 g/mol which may be mentioned by way of example are: 1,2-ethanediol, 1,2-propanediol, 1,3-propanediol, 1,2-butanediol, 1,3-butanediol, 1,4-butanediol, 1,4-but-2-enediol, 1,4-but-2-ynediol, 1,5-pentanediol and positional isomers thereof, 1,6-hexanediol, 1,8-octanediol, 1,4-bishydroxymethylcyclohexane, 2,2-bis-(4-hydroxycyclohexyl)propane, 2-methyl-1,3-propanediol, diethylene glycol, triethylene glycol, tetraethylene glycol and, in particular, 2,2-dimethylpropane-1,3-diol (neopentyl glycol).

As polymeric diols, dihydric or polyhydric polyester polyols and polyether polyols may be mentioned, with the dihydric being preferred. As polyether polyols, preferably polyether diols come into consideration as are obtainable, for example, by boron trifluoride-catalyzed linking of ethylene oxide, propylene oxide, butylene oxide, tetrahydrofuran, styrene oxide or epichlorohydrin with itself or among one another or by addition of these compounds, individually or in a mixture, to starter components having reactive hydrogen atoms such as water, polyhydric alcohols, or amines such as 1,2-ethanediol, propane-(1,3)-diol, 1,2- or 2,2-bis-(4-hydroxyphenyl)propane or aniline. In addition, polyether-1,3-diols, for example trimethylol propane alkoxylated at an OH group, the alkylene oxide chain of which is closed with an alkyl radical comprising 1 to 18 carbon atoms, are preferably used polymeric diols.

Preferred polymeric diols are: polyethylene glycol, polypropylene glycol and, in particular, polytetrahydrofuran (poly-THF).

Particularly preferably, polyether polyols are selected from: polyethylene glycol having a mean molecular weight (Me) in the range from 200 to 9000 g/mol, preferably in the range from 500 to 6000 g/mol, poly-1,2-propylene glycol or poly-1,3-propane diol having a mean molecular weight (Mₙ) in the range from 250 to 6000, preferably 600 to 4000 g/mol, poly-THF having a mean molecular weight (Mₙ) in the range from above 250 to 5000, preferably from 500 to 3000 g/mol, particularly preferably in the range from 750 to 2500 g/mol.

Other preferred polymeric diols are polyester polyols (polyester diols) and polycarbonate diols.

As polycarbonate diols, in particular aliphatic polycarbonate diols may be mentioned, for example 1,4-butanediol polycarbonate and 1,6-hexanediol polycarbonate.

As polyester diols, those which may be mentioned are those which may be produced by polycondensation of at least one primary diol, preferably at least one primary aliphatic diol, for example ethylene glycol, 1,4-butanediol, 1,6-hexanediol, neopentyl glycol or, particularly preferably, 1,4-dihydroxymethylcyclohexane (as mixture of isomers) or mixtures of at least two of the abovementioned diols on the one hand and at least one, preferably at least two, dicarboxylic acids or anhydrides thereof on the other. Preferred dicarboxylic acids are aliphatic dicarboxylic acids such as adipic acid, glutaric acid, succinic acid and aromatic dicarboxylic acids such as, for example, phthalic acid and, in particular, isophthalic acid.

In one embodiment of the present invention, polyester diols and polycarbonate diols are selected from those having a mean molecular weight (Mₙ) in the range from 500 to 9000 g/mol, preferably in the range from 500 to 6000 g/mol.

Very particularly preferred diols (B) are polytetrahydrofurans, for example having a mean molecular weight Mₙ in the range from 250 to 2000 g/mol.

In one embodiment of the present invention, polymeric material according to the invention has an acid value in the range from zero to 300 mg of KOH/g, determined as specified in DIN 53402, preferably zero to 200 mg of KOH/g.

In one embodiment of the present invention, polymeric material according to the invention has a hydroxyl number in the range from zero to 300 mg of KOH/g, determined as specified in DIN 53240-2, preferably zero to 200 mg of KOH/g.

In one embodiment of the present invention, polymeric material according to the invention has a quotient M_{w}/Mₙ in the range from 1.2 to 10, preferably 1.5 to 5, particularly preferably 1.8 to 4. In this case, M_{w} and Mₙ are preferably determined by gel-permeation chromatography.

The present invention further relates to the use of polymeric materials according to the invention as, or for production of, materials for separation of matter, for example as, or for production of, stationary phases for chromatography, preferably as, or for production of, membranes. The present invention further relates to a method for producing materials for separation of matter, in particular for producing stationary phases for chromatography, or membranes, using at least one material according to the invention. The present invention further relates to materials for separation of matter, for example stationary phases for chromatography, and in particular membranes, produced using at least one polymeric material according to the invention.

Membranes according to the invention can have a mean thickness in the range from 0.01 to 100 μm, preferably 1 to 50 μm, particularly preferably 1 to 20 μm.

Membranes according to the invention can be constructed as hollow-fiber membranes or flat membranes. Specific examples of flat membranes are coiled membranes.

Membranes according to the invention are suitable for membrane separation methods, in particular for nanofiltration, gas separation, pervaporation, reverse osmosis, microfiltration and ultrafiltration, in particular nanofiltration and ultrafiltration, with substances dissolved in organic solvents.

In this case nanofiltration, in the context of the present invention, is taken to mean a membrane separation method in which the membrane used, in the case of non-porous membranes, has a separation limit (Molecular Weight Cut-Off, MWCO) from 100 to 1500 g/mol or—in variants of porous membranes, a maximum pore diameter of 1 nm. Using nanofiltration, for example substances may be separated off which have a mean molecular weight of less than 0.1, or less than 1.5 kg/mol, that is to say less than 100, or less than 1500 g/mol.

Ultrafiltration, in the context of the present invention, is taken to mean a membrane separation method in which the membrane has a molecular weight cut-off in the range from 1500 to 1 000 000 g/mol, or separates off particles that have a maximum diameter in the range from 10 to 500 nm.

Microfiltration, in the context of the present invention, is taken to mean a membrane separation method in which the membrane has a molecular weight cut-off above 1 000 000 g/mol, or a pore diameter from 1 μm to 10 μm.

In order to produce membranes from polymeric material according to the invention, a procedure can, for example, be followed in such a manner that polymeric material according to the invention is crosslinked with an exactly calculated amount of a crosslinker, for example a diisocyanate or polyisocyanate, more precisely on a solid surface. As polyisocyanates, those can be selected that are mentioned under polyisocyanate (a). The amount of crosslinker can be calculated, for example, on the basis of the OH number or acid value of polymeric material according to the invention on the one hand and the number of functional groups, for example NCO groups, of crosslinker on the other.

In a further embodiment of the present invention, membranes according to the invention are produced by applying a solution comprising at least one organic solvent, at least one crosslinker and at least one polymeric material according to the invention in the form of a film to an article having a smooth surface, for example to a plastic plate or a glass plate. Thereafter, the solvent or solvents is vaporized and the plate is thermally treated, for example in a range from 20° C. to 400° C., preferably 40 to 200° C., particularly preferably 50 to 150° C. In this process a crosslinking reaction takes place in situ. The desired crosslinking can be accelerated by adding a catalyst. Finally, a membrane according to the invention can be taken off simply from the article having a smooth surface after the thermal treatment.

In one embodiment of the present invention, a membrane according to the invention is joined to a further layer, preferably to a silicone layer, for example by lamination.

In another embodiment, membranes according to the invention can be spun as hollow-fiber membranes. Such membranes according to the invention are particularly highly suitable for gas separation, but also as protective layers.

Membranes according to the invention can be constructed as integrally asymmetric or as composite membranes, in which the actual separation layer effecting the separation, which has a thickness of 0.01 to 100 μm, preferably 0.1 to 20 μm, is applied to one or more mesoporous and/or macroporous support(s) which comprise(s) one or more organic, in particular polymeric, and/or inorganic materials, for example ceramic, carbon, metal.

Membranes according to the invention can be used in the form of flat, cushion, capillary, hollow fiber, monochannel tubular or multichannel tubular elements. The geometries are known to those skilled in the art, per se, from other membrane separation methods such as ultrafiltration or reverse osmosis (see, e.g. R. Rautenbach “Membranverfahren, Grundlagen der Modul- and Anlagenauslegung” [Membrane Methods, Fundamentals of Module and System Design], 1997, Springer Verlag). In the case of membrane elements having a tubular geometry, the separation layer can be situated on the inside or outside of the tube.

In a further embodiment of the present invention, membranes according to the invention are surrounded with one or more housings made of polymeric, metallic or ceramic material, wherein the connection between housing and membrane is formed by a sealing polymer (e.g. elastomer) or by an inorganic material.

The present invention further relates to a method for separating mixtures of matter, using polymeric material according to the invention, for example in the form of membranes according to the invention or stationary phases according to the invention for chromatography. Methods according to the invention for separating mixtures of matter, using material according to the invention for separation of matter, will hereinafter also be called separation methods according to the invention.

Materials according to the invention for separation of matter, for example membranes according to the invention or chromatographic columns according to the invention, are suitable, e.g., for the following separation tasks, i.e. for separating the following mixtures of matter:

Polyalkylene glycols of various molecular weights, for example polyethylene glycol/polypropylene glycol block copolymers 6500 g/mol—polyethylene glycol 400 g/mol Separating off homogeneous or heterogeneous catalysts from organic solvents

Monomer/dimer separation
Decolorization of organic solutions

### Desalination

Membranes according to the invention, in many cases, do not show permeability to water, even after conditioning in THF. In contrast, membranes according to the invention exhibit good permeability to organic solvents, for example acetone, toluene, isopropanol and ethanol.

Membranes according to the invention are flexible and simple to cut. In many cases, membranes according to the invention are thermally stable, for example up to a temperature of 200° C.

The present invention further relates to a method for producing polymeric materials according to the invention, also called production method according to the invention for short. For carrying out the production method according to the invention, a procedure can be followed such that a polyimide (A) obtainable by condensation of
(a) at least one polyisocyanate having on average at least two isocyanate groups per molecule and
(b) at least one polycarboxylic acid having at least 3 COOH groups per molecule or anhydride thereof
   is reacted with
      (B) at least one diol.

Preferably, polyimide (A) has a polydispersity M_{w}/Mₙ of at least 1.4.

Polyimide (A), polyisocyanate (a), polycarboxylic acid (b), anhydride (b) and diol (B) are described hereinbefore.

The production method according to the invention is a two-step method. It is possible in this case, after the production of polyimide (A), to isolate it and purify it. In another variant, the production method according to the invention is carried out as a one-pot method and the purification and isolation of polyimide (A) are omitted.

For carrying out the synthesis method according to the invention, polyisocyanate (a) and polycarboxylic acid (b) or anhydride (b) can be used in a quantitative ratio such that the molar fraction of NCO groups to COOH groups is in the range from 1:3 to 3:1, with preference given to 1:2 to 2:1. In this case, one anhydride group of the formula CO—O—CO counts as two COOH groups.

In one embodiment of the present invention, polyimide (A) and diol (B) are used in quantitative ratios such that the molar ratio of the hydroxyl groups from diol (B) to the sum of NCO groups and COOH groups is 1:10 to 10:1, preferably 1:6 to 6:1, particularly preferably 1:4 to 4:1.

In one embodiment of the present invention, catalyst can be used in the range from 0.005 to 0.1% by weight, based on the sum of polyisocyanate (a) and polycarboxylic acid (b), or polyisocyanate (a) and anhydride (b). Preference is given to 0.01 to 0.05% by weight catalyst.

In one embodiment of the present invention, the synthesis method according to the invention can be carried out at temperatures in the range from 50 to 140° C.; preference is given to 50 to 100° C.

In one embodiment of the present invention, the production method according to the invention can be carried out at atmospheric pressure. However, synthesis under pressure, for example at pressures in the range from 1.1 to 10 bar, is also possible.

In one embodiment of the present invention, the synthesis method according to the invention can be carried out in the presence of a solvent or solvent mixture. Examples of suitable solvents are N-methylpyrrolidone, N-ethylpyrrolidone, dimethylformamide, dimethylacetamide, dimethyl sulfoxide, dimethyl sulfone, xylene, phenol, cresol, ketones, for example acetone, methyl ethyl ketone (MEK), methyl isobutyl ketone (MIBK), acetophenone, in addition mono- and dichlorobenzene, ethylene glycol monoethyl ether acetate, and mixtures of two or more of the abovementioned solvents. In this method the solvent or solvents can be present during the entire period of the synthesis or only during part of the synthesis.

For example, the reaction can be carried out over a period of 10 minutes to 24 hours.

In a variant of the synthesis method according to the invention, NCO end groups of polyimide (A) can be blocked with secondary amine, for example with dimethylamine, di-n-butylamine or with diethylamine.

In one embodiment of the present invention, the production method according to the invention is carried out without addition of a catalyst.

In another embodiment of the present invention, the production method according to the invention is carried out using a catalyst, for example by adding at least one catalyst usual in polyurethane chemistry.

As catalysts, in particular water and Brønsted bases are suitable, for example alkali metal alcoholates, in particular alkanolates of sodium or potassium, for example sodium methanolate, sodium ethanolate, sodium phenolate, potassium methanolate, potassium ethanolate, potassium phenolate, lithium methanolate, lithium ethanolate and lithium phenolate.

In addition, suitable catalysts are tertiary amines, amidines and/or organic metal compounds.

Examples are 2,3-dimethyl-3,4,5,6-tetrahydropyrimidine, tertiary amines such as triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethyl-hexanediamine, pentamethyldiethylenetriamine, tetramethyldiaminoethyl ether, bis-(dimethylaminopropyl)urea, dimethylpiperazine, 1,2-dimethylimidazole, 1-azabicyclo-(3,3,0)-octane and preferably 1,4-diazabicyclo-(2,2,2)-octane and alkanolamine compounds such as triethanolamine, triisopropanolamine, N-methyl- and N-ethyldiethanolamine and dimethylethanolamine. Likewise, as catalysts, metal compounds come into consideration, preferably tin compounds such as tin(II) salts of organic carboxylic acids, e.g. tin(II) acetate, tin(II) octoate, tin(II) ethyl hexoate and tin(II) laurate, and preferably organotin compounds, particularly preferably dialkyltin(IV) salts of organic carboxylic acids, in particular di-n-C₁-C₁₀-alkyl tinalkanoates, e.g. di-n-butyltin diacetate, di-n-butyltin dilaurate, di-n-butyltin maleate and di-n-octyltin diacetate, and also bismuth carboxylates, such as bismuth(III) neodecanoate, bismuth 2-ethylhexanoate and bismuth octanoate, or mixtures thereof. Metal compounds or organometallic compounds can be used alone or in combination with basic amines.

As a further preferred catalyst, di-n-butyltin mercaptide is used, or di-n-butyltin dioctanoate.

In a preferred embodiment of the present invention, the synthesis method according to the invention is carried out under inert gas, for example under argon or under nitrogen.

If a water-sensitive Brønsted base is used as catalyst, it is preferred to dry inert gas and solvent. If water is used as catalyst, the drying of solvent and inert gas can be omitted.

The production method according to the invention produces—optionally after a workup, for example after removal of solvent—polymeric material according to the invention.

The invention is illustrated by working examples.

### General Notes:

Polyisocyanate (a.1): 4,4′-diphenylmethane diisocyanate
Anhydride (b.1): 1,2,4,5-benzenetetracarboxylic dianhydride

The molecular weights were determined by gel-permeation chromatography (GPC). The standard used was polystyrene (PS). The solvent used was tetrahydrofuran (THF), where not explicitly stated otherwise. Detection was performed using an Agilent 1100 differential refractometer or an Agilent 1100 VWD UV photometer.

The NCO content was determined titrimetrically as specified in DIN EN ISO 11 909 and reported in % by weight.

The syntheses were carried out under nitrogen, if not described otherwise.

### SYNTHESIS EXAMPLES

### I. Production of Polymeric Materials According to the Invention

### I.1 Synthesis of Polymeric Material (PM.1) According to the Invention

In a 4-I four-neck flask having a dropping funnel, reflux cooler, internal thermometer and Teflon agitator, 100 g (0.46 mol) of anhydride (b.1) were placed, dissolved in 1400 ml of acetone which was not dried before the reaction and therefore comprised water. Then, 173 g (0.69 mol) of polyisocyanate (a.1) were added dropwise at 20° C. The mixture was heated with stirring to 55° C. The mixture was stirred for a further six hours under reflux at 55° C. Thereafter, 600 g of poly-THF having a mean molecular weight Mₙ of 1000 g/mol (0.6 mol) were added. The temperature was increased to 60° C. and acetone was distilled off at atmospheric pressure in the course of 4 hours. Thereafter, the mixture was heated to 125° C. and the pressure decreased to 200 mbar. Thereafter, the residue was stripped in the flask with nitrogen. This produced polymeric material (PM.1) according to the invention as a solid yellow mass.

Mₙ=8360 g/mol, M_{w}=21 000 g/mol

### M_{w}/Mₙ=2.5

OH number: 22 mg of KOH/g
Acid value: 88 mg of KOH/g

### I.2 Synthesis of Polymeric Material (PM.2) According to the Invention

In a 4-I four-neck flask having a dropping funnel, reflux cooler, internal thermometer and Teflon agitator, 100 g (0.46 mol) of anhydride (b.1) were placed, dissolved in 1400 ml of acetone which was not dried before the reaction and therefore comprised water. Then 115 g (0.46 mol) of polyisocyanate (a.1) were added dropwise at 20° C. The mixture was heated with stirring to 55° C. The mixture was stirred for a further six hours under reflux at 55° C. Thereafter, 1000 g of poly-THF having a mean molecular weight Mₙ of 1000 g/mol (1.0 mol) were added and the mixture was stirred under reflux at 55° C. for 14 hours. The temperature was increased to 60° C. and acetone was distilled off in the course of 4 hours at atmospheric pressure. Thereafter, the mixture was heated to 125° C. and the pressure was reduced to 200 mbar. Thereafter, the residue was stripped in the flask with nitrogen. This produced polymeric material (PM.2) according to the invention as a solid yellow mass.

Mₙ=7250 g/mol, M_{w}=16 900 g/mol

### M_{w}/Mₙ=2.3

OH number: 26 mg of KOH/g
Acid value: 40 mg of KOH/g

### I.3 Synthesis of Polymeric Material (PM.3) According to the Invention

In a 4-I four-neck flask having a dropping funnel, reflux cooler, internal thermometer and Teflon agitator, 100 g (0.46 mol) of anhydride (b.1) were placed, dissolved in 1400 ml of acetone which was not dried before the reaction and therefore comprised water. Then, 115 g (0.69 mol) of polyisocyanate (a.1) were added dropwise at 20° C. The mixture was heated to 55° C. with stirring. The mixture was stirred for a further six hours under reflux at 55° C. Thereafter, 300 g of poly-THF having a mean molecular weight Mₙ of 1000 g/mol (0.3 mol) were added. The mixture was stirred for a further six hours under reflux at 55° C. and thereafter the temperature was increased to 60° C. and acetone was distilled off in the course of 4 hours at atmospheric pressure. Thereafter, the mixture was heated to 125° C. and the pressure was reduced to 200 mbar. Thereafter, the residue was stripped in the flask with nitrogen. This produced polymeric material (PM.3) according to the invention as a solid yellow mass.

Mₙ=3670 g/mol, M_{w}=11 900 g/mol

### M_{w}/Mₙ=3.2

OH number: 37 mg of KOH/g
Acid value: 144 mg of KOH/g

### I.4 Synthesis of Polymeric Material (PM.4) According to the Invention

In a 4-I four-neck flask having a dropping funnel, reflux cooler, internal thermometer and Teflon agitator, 100 g of anhydride (b.1) (0.46 mol) were placed, dissolved in 1400 ml of acetone which was not dried before the reaction and therefore comprised water. Then, 173 g (0.69 mol) of polyisocyanate (a.1) were added dropwise at 20° C. The mixture was heated to 55° C. with stirring. The mixture was stirred for a further five hours under reflux at 55° C. Thereafter, 390 g of poly-THF having a mean molecular weight Mₙ of 650 g/mol (0.6 mol) were added. The temperature was increased to 60° C. and acetone was distilled off in the course of 7 hours at atmospheric pressure. Thereafter, the mixture was heated to 80° C. and the pressure was reduced to 200 mbar. Thereafter, the residue was stripped in the flask with nitrogen. This produced polymeric material (PM.4) according to the invention as a solid yellow mass.

Mₙ=5900 g/mol, M_{w}=14 000 g/mol

### M_{w}/Mₙ=2.4

OH number: 14 mg of KOH/g
Acid value: 107 mg of KOH/g

### I.5 Synthesis of Polymeric Material (PM.5) According to the Invention

In a 4-I four-neck flask having a dropping funnel, reflux cooler, internal thermometer and Teflon agitator, 100 g (0.46 mol) of anhydride (b.1) were placed, dissolved in 1400 ml of acetone which was not dried before the reaction and therefore comprised water. Then, 173 g (0.69 mol) of polyisocyanate (a.1) were added dropwise at 20° C. The mixture was heated to 55° C. with stirring. The mixture was stirred for a further five hours under reflux at 55° C. Thereafter, 173 g of poly-THF having a mean molecular weight Mₙ of 250 g/mol (0.6 mol) were added. The temperature was increased to 60° C. and acetone was distilled off in the course of 7 hours at atmospheric pressure. Thereafter the mixture was heated to 80° C. and the pressure reduced to 200 mbar. Thereafter, the residue was stripped in the flask with nitrogen. This produced polymeric material (PM.5) according to the invention as a solid yellow mass.

Mₙ=4360 g/mol, M_{w}=8370 g/mol

### M_{w}/Mₙ=1.9

OH number: 12 mg of KOH/g
Acid value: 151 mg of KOH/g

### II. Production of a Membrane According to the Invention from (PM.1) or (PM.3), General Method

In a glass beaker, polymeric material according to the invention as per Table 1 was weighed and 1,3-dioxolane was added as solvent. The mixture was stirred for a period of 30 minutes using a magnetic stirrer and this produced a transparent solution. Then, crosslinker (CL.1) as per Table 1 was added and the mixture was stirred for a further 5 minutes.

Thereafter, a membrane was produced using a laboratory spreader. For this purpose a spreader bench (Erichsen, Coatmaster 509 MC-1) was adjusted to 80° C. and the above-described solution was poured onto a glass plate with a wet-film thickness of 100 μm. A film was then drawn from the solution onto a glass plate which had a wet-film thickness of 100 μm. The wet film was dried in air for 15 minutes and was then placed into a room-temperature waterbath for 24 hours. Then, the product was dried for 24 hours in a vacuum drying cabinet at 80° C. This produced membranes according to the invention.

Crosslinker used: (CL.1): polymeric 4,4′-diphenylmethane diisocyanate having functionality of 2.7, NCO: 31.5%

TABLE 1
Experimental details for producing materials according to the invention

| Membrane | Starting material | Crosslinker | (PM) [g] | Crosslinker (CL. 1) [g] |
|---|---|---|---|---|
| MEMB. 1 | (PM. 1) | (CL. 1) | 6.0 | 1.57 |
| MEMB. 3 | (PM. 3) | (CL. 1) | 6.0 | 2.58 |

The MWCO of the membranes according to the invention MEMB.1 and MEMB.3 was about 6.5 kg/mol, determined by determining the retention of a 10% by weight solution of polyethylene glycol (M_{w} 400 g/mol) and of a polyethylene glycol/polypropylene glycol block copolymer (having an M_{w}=6500 g/mol) in THF.

1. A polymeric material obtainable by reaction of
(A) at least one polyimide selected from condensation products of
(a) at least one polyisocyanate having on average at least two isocyanate groups per molecule and
(b) at least one polycarboxylic acid having at least 3 COOH groups per molecule or anhydride thereof, with
(B) at least one diol or triol.

2. The polymeric material according to claim 1, wherein polyimide (A) is selected from those polyimides that have a molecular weight M_{w} of at least 1000 g/mol.

3. The polymeric material according to claim 1 or 2, wherein, as polycarboxylic acid (b), a polycarboxylic acid having at least 4 COOH groups per molecule is selected, or the respective anhydride.

4. The polymeric material according to any one of claims 1 to 3, wherein polyisocyanate (a) is selected from hexamethylene diisocyanate, tetramethylene diisocyanate, isophorone diisocyanate, 4,4′-diphenylmethane diisocyanate, 2,4′-diphenylmethane diisocyanate, toluoylene diisocyanate and mixtures of at least two of the above-mentioned polyisocyanates (a).

5. The polymeric material according to any one of claims 1 to 3, wherein polyisocyanate (a) is selected from oligomeric hexamethylene diisocyanate, oligomeric tetramethylene diisocyanate, oligomeric isophorone diisocyanate, oligomeric diphenylmethane diisocyanate, trimeric toluoylene diisocyanate and mixtures of at least two of the abovementioned polyisocyanates (a).

6. The polymeric material according to any one of claims 1 to 5, wherein diol (B) is selected from diols having a molecular weight M_{w} in the range from 250 to 5000 g/mol.

7. The polymeric material according to any one of claims 1 to 6, wherein diol (B) is selected from polyethylene glycols, polypropylene glycols, polyester diols, polycarbonate diols and polytetrahydrofuran.

8. The polymeric material according to any one of claims 1 to 7, which has an acid value in the range from zero to 300 mg of KOH/g.

9. The polymeric material according to any one of claims 1 to 8, which has a hydroxyl number in the range from zero to 300 mg of KOH/g.

10. The use of polymeric material according to any one of claims 1 to 9 as or for production of membranes.

11. A method for producing membranes, using at least one polymeric material according to any one of claims 1 to 9.

12. A membrane containing, or produced using, at least one polymeric material according to any one of claims 1 to 9.

13. The use of membranes according to claim 12 in membrane separation methods.

14. The use of polymeric materials according to any one of claims 1 to 9 as stationary phase in chromatography.

15. A method for producing polymeric materials according to any one of claims 1 to 9, which comprises reaction of a polyimide (A), obtainable by condensation of
(a) at least one polyisocyanate having on average at least two isocyanate groups per molecule and
(b) at least one polycarboxylic acid having at least 3 COOH groups per molecule or anhydride thereof
with
(B) at least one diol or triol.

16. The method according to claim 15, wherein polyimide (A) is reacted with diol (B) using a catalyst.

17. The method according to claim 16, wherein the catalyst is selected from di-n-C₁-C₁₀-alkyltin alkanoates.
